(19) United States
(12) Patent Application Publication
(10) Pub. No.: US 2007/0004876 A1
(43) Pub. Date: Jan. 4, 2007

(54) Cocatalysts for olefin polymerizations

(75) Inventors: Kayo Vizzini, Pasadena, TX (US); Steve Gray, Bellaire, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/472,153

(22) Filed: Jun. 21, 2006

Related U.S. Application Data
(60) Provisional application No. 60/692,911, filed on Jun. 22, 2005.

(51) Int. Cl. C08F 2/00

(52) U.S. Cl. 526/64; 526/124.3; 526/348.5; 526/348.6; 526/283; 526/280; 526/335

(57) ABSTRACT

Commonly used triethyl aluminum and tri-isobutyl aluminum cocatalysts may be replaced in olefin polymerizations with a cocatalyst conforming to the formula
AlR^{z}(X^{z})ₙL^{z}ₘ
wherein R^{z} may be a linear or branched organic moiety having at least 5 carbons and X^{z} may be a linear or branched organic moiety having at least 5 carbons or heteroatom substituted organic moiety or a heterocyclic moiety having at least 4 atoms and may be anionic (n=2) or dianionic (n=1). One X^{z} may also be hydrogen. The aluminum complex may also be in the form of an adduct complex where L^{z} may be a Lewis base and m=1−3. In the absence of a Lewis base, m=0.

### 1. CROSS REFERENCE TO RELATED APPLICATIONS

This application claims priority from the commonly-owned and co-pending provisional patent application having Ser. No. 60/692,911 that was filed on Jun. 22, 2005 and titled “COCATALYSTS FOR OLEFIN POLYMERIZATIONS,” which is fully incorporated herein by reference.

### BACKGROUND OF THE INVENTION

2. Technical Field

This invention relates to polymers. More particularly, it relates to polymers prepared with Ziegler-Natta catalysts.

3. Background of the Art

Olefins, also called alkenes, are unsaturated hydrocarbons whose molecules contain one or more pairs of carbon atoms linked together by a double bond. When subjected to a polymerization process, olefins may be converted to polyolefins, such as polyethylene and polypropylene. One commonly used polymerization process involves contacting an olefin monomer with a Ziegler-Natta catalyst system. Ziegler-Natta catalysts, their general methods of making, and subsequent use, are well known in the polymerization art.

Cocatalysts are often components of Ziegler-Natta catalyst systems. Frequent and effective choices of cocatalysts for these production runs are tri-isobutylaluminum (“TIBAl”) and tri-ethylaluminum (“TEAl”). However, production difficulties may be encountered using these cocatalysts. For example, TEAl may couple ethylene to produce butene, which in some processes may be an unwanted species. In some applications, TIBAl may decompose to form isobutylene which may also be an unwanted olefinic impurity. Both butene and isobutylene may be difficult to separate from the isobutane diluents.

It would therefore be desirable in the art to identify a means to avoid the problems associated with the use of certain aluminum alkyls, such as TEAl and TIBAl, as cocatalysts in Ziegler-Natta catalyzed olefin polymerizations.

### SUMMARY OF THE INVENTION

In one aspect, the invention is a process for preparing a polyolefin, the process including using as components in a polymerization mixture a Ziegler-Natta Catalyst, a polymerization diluent, and a cocatalyst having the formula:
AlR^{z}(X^{z})ₙ
wherein R^{z} is a linear or branched organic moiety having at least 5 carbons, X^{z} is a linear or branched organic moiety having at least 5 carbons or heteroatom substituted organic moiety or a heterocyclic moiety having at least 4 atoms and may be anionic (n=2) or dianionic (n=1). One X^{z} may additionally be hydrogen. The general formula is subject to the proviso that when n=2, each X^{z} may be the same or different and that both X^{z} moieties may not be hydrogen.

In another aspect the invention is a polymer prepared using a process for preparing a polyolefin, the process including using as components in a polymerization mixture a Ziegler-Natta Catalyst, a polymerization diluent, and a cocatalyst conforming to the formula:
AlR^{z}(X^{z})ₙ
wherein R^{z} is a linear or branched organic moiety having at least 5 carbons, and X^{z} is a linear or branched organic moiety having at least 5 carbons or heteroatom substituted organic moiety or a heterocyclic moiety having at least 4 atoms and may be anionic (n=2) or dianionic (n=1). X^{z} may also additionally be hydrogen. The general formula is subject to the proviso that when n=2, each X^{z} may be the same or different and that both X^{z} moieties may not be hydrogen.

In still another aspect the invention is an article of manufacture prepared from the polymer prepared using a process for preparing a polyolefin, the process including using as components in a polymerization mixture a Ziegler-Natta Catalyst, a polymerization diluent, and a cocatalyst conforming to the formula:
AlR^{z}(X^{z})ₙ
wherein R^{z} is a linear or branched organic moiety having at least 5 carbons, and X^{z} is a linear or branched organic moiety having at least 5 carbons or heteroatom substituted organic moiety or a heterocyclic moiety having at least 4 atoms and may be anionic (n=2) or dianionic (n=1). One X^{z} may also additionally be hydrogen.

Use of the invention enables production of a polyolefin resin, such as polyethylene, and articles of manufacture prepared therefrom, which may exhibit improved properties, such as higher bulk density and shear thinning behavior and broader molecular weight distributions when compared with properties of resins prepared using other cocatalysts such as TIBAl and/or TEAl.

### BRIEF DESCRIPTION OF THE FIGURES

For a detailed understanding and better appreciation of the invention, reference should be made to the following detailed description of the invention taken in conjunction with the accompanying drawings, wherein:

FIG. 1 is a plot of molecular weight distribution as a function of molar aluminum, [Al], concentration from the cocatalyst for polymers prepared in Example 1, Comparative Example 1 and Comparative Example 2; and

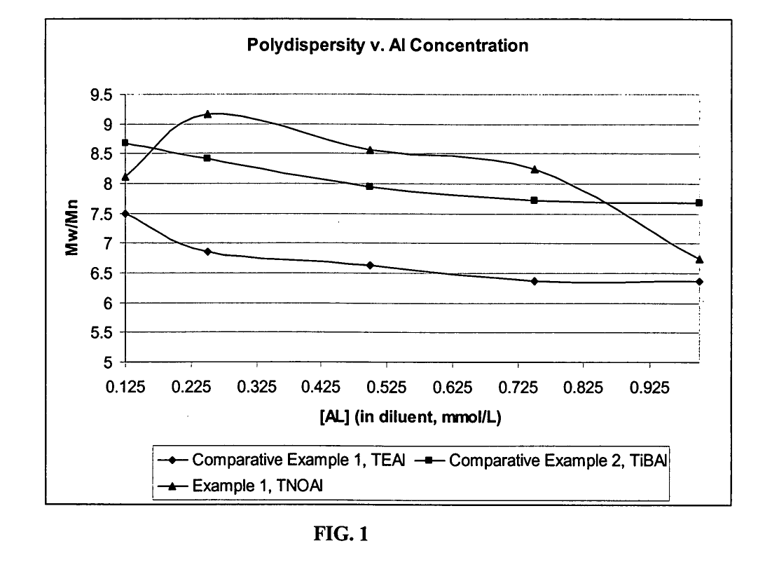

FIG. 2 is a plot of bulk density as a function of molar aluminum concentration from the cocatalyst for polymers prepared in Example 1, Comparative Example 1 and Comparative Example 2.

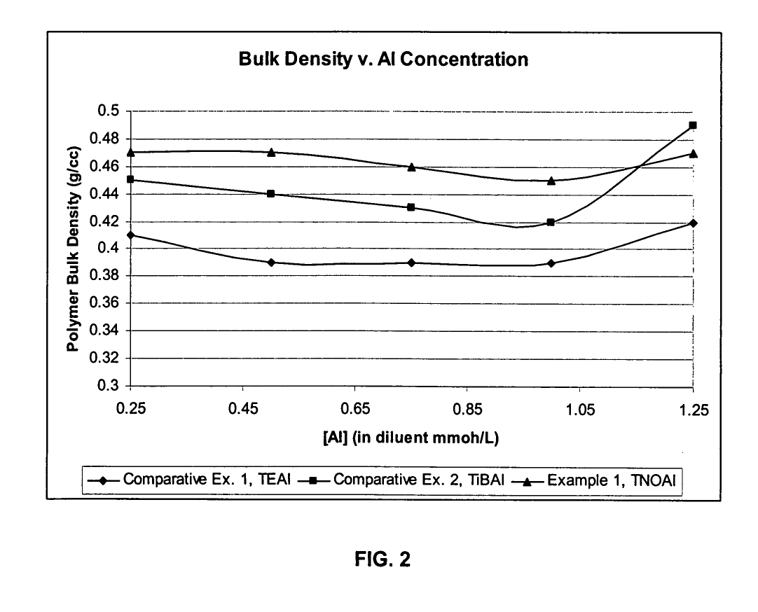

### DETAILED DESCRIPTION OF THE INVENTION

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology. Various terms as used herein are shown below. To the extent a term used in a claim is not defined below, it should be given the broadest definition persons in the pertinent art have given that term as reflected in printed publications and issued patents.

The invention offers an easy and effective means of preparing polyolefin resins using a Ziegler-Natta catalyst system. The invention may be practiced with reduced occurrence of certain production problems and improvements, in some embodiments, in certain polymer properties, such as bulk density, molecular weight distribution, and/or shear thinning capability. Other cocatalysts not within the scope of Formula I, such as TEAl and TIBAl for example, may be troublesome in polymerization. TIBAl, for example, may decompose to provide isobutylene that may adversely affect polymerization behavior and final product properties. TEAl may not result in a build-up of isobutylene, but it may produce alpha olefins such as 1-butene. Like isobutylene, this C₄ alkene may also not be readily removed from reactor recycle streams of certain processes and may become an unwanted olefin source that may also be undesirable in some applications.

For purpose of this invention, the term “undesired olefin” refers to any olefin that may not be readily isolated from the diluent employed for the reaction or used in various other functions in the production process such. For example, in a process occurring in a diluent such as isobutane, the process will be negatively affected by isobutylene. Similarly, a hexane-based process will be negatively affected by undesired production of hexene.

In contrast, cocatalysts conforming to Formula I do not readily decompose to provide undesired olefins inherently difficult to separate from the diluent recycle streams.

The cocatalysts may be in the form of Formula I, which has the general formula:
AlR^{z}(X^{z})ₙ Formula I
wherein R^{z} may be a linear or branched organic moiety having at least 5 carbons, and X^{z} may be a linear or branched organic moiety having at least 5 carbons or a heterocyclic moiety having at least 4 atoms and may be anionic (n=2) or dianionic (n=1).

As shown in Formula Ia:
AlR^{z}(X^{z})ₙL^{z}ₘ Formula Ia
the aluminum complex may also be in the form of an adduct where L^{z} may be an optional Lewis base. If the Lewis base is present, then in some embodiments, m=1−3. R^{z} is chosen such that it does not readily decompose or react to produce undesirable olefinic compounds, such as isobutylene or butene, in the production process.

In Formula I and Ia, R^{z} may be a linear or branched organic moiety having at least 5 carbons, while X^{z} may be selected from a wide variety of organic moieties. Such moieties may include, for example, alkyls, cycloalkyls, halides, alkenyls, substituted alkyls, aryls, arylhalides, alkoxys, amides mixtures thereof, and the like. For example, in one embodiment, the cocatalyst may be Al(n-Octyl)(OBu)₂.

Heterocyclic moieties may also be selected. The ring of the heterocyclic compound may, for example, include at least one nitrogen, oxygen, and/or sulfur atom. In one embodiment, X^{z} may be a heterocyclic moiety and includes at least one nitrogen atom. Such heterocyclic compounds may include 4 or more ring members in one embodiment, and 5 or more ring members in another embodiment.

Where a heterocyclic compound is selected for use, it may be unsubstituted or substituted with one or a combination of substituent groups. Examples of suitable substituents include halogen, alkyl, alkenyl or alkynyl radicals, cycloalkyl radicals, aryl radicals, aryl substituted alkyl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals, and any combination thereof. The substituents groups may also be substituted with halogens, particularly fluorine or bromine, or heteroatoms or the like. The general formula is subject to the proviso that when n=2, each X^{z} may be the same or different and that both X^{z} moieties may not be hydrogen.

In Formula I and Ia, for X^{z}, non-limiting examples of hydrocarbon substituents include methyl, ethyl, propyl, butyl, pentyl, hexyl, cyclopentyl, cyclohexyl, benzyl and phenyl groups and the like, including all their isomers, for example tertiary butyl, isopropyl, and the like. Other examples of substituents include fluoromethyl, fluoroethyl, difluoroethyl, iodopropyl, bromohexyl and chlorobenzyl.

In one embodiment, the heterocyclic compound may be unsubstituted. In another embodiment one or more positions on the heterocyclic compound are substituted with a halogen atom or a halogen atom containing group, for example a halogenated aryl group. In one embodiment the halogen may be selected from the group consisting of chlorine, bromine and fluorine; and selected from the group consisting of fluorine and bromine in another embodiment; and the halogen may be fluorine in yet another embodiment.

Non-limiting examples of heterocyclic compounds which may be utilized as the X^{z} moiety, include substituted and unsubstituted pyrroles, imidazoles, pyrazoles, pyrrolines, pyrrolidines, carbazoles, and indoles, phenyl indoles, 2,5,-dimethylpyrroles, 3-pentafluorophenylpyrrole, 4,5,6,7-tetrafluoroindole and 3,4-difluoropyrroles.

Further, if X^{z} is a monoanionic ligand, then n=2. If X^{z} is a dianionic ligand, then n=1. Where n=2, R^{z} and X^{z} may be the same or differnt. For example, in one embodiment, a particularly useful cocatalyst may be tri-n-octylaluminum (TNOAl). In another embodiment, a particularly useful cocatalyst may be tri-n-hexylaluminum. Combinations and mixtures of cocatalysts of the invention may also be used. Such combinations and mixtures of suitable catalysts may also be employed so long as the criteria above are met.

Additionally, L^{z}, if present, may be a Lewis base selected from ethers, aliphatic amines, aromatic amines and phosphines. Mixtures of Lewis bases may also be used. For example, in one embodiment, L^{z} may be diethyl ether. In another embodiment, L^{z} may be a mixture of diethyl ether and triethylamine. When present, the L^{z} component may be present at a molar ratio of L^{z} to cocatalyst of up to 3:1. Aluminum species are known to exchange ligands of this class according to the process:
AlR^{z}(X^{z})ₙL^{z}ₘ+L^{z}′⇄AlR^{z}(X^{z})ₙL^{z}ₘ₋₁L^{z}′+L^{z} (where m is less than or equal to 3).
Excess ligand, L^{z}, may also be present to retard ligand dissociation and the formation of lower coordination; conversely, a slight amount such as 0.1 equivalents may be added to favor the formation of a slightly higher coordination about the aluminum center:
AlR^{z}(X^{z})ₙL^{z}ₘ+L^{z}′⇄AlR^{z}(X^{z})ₙL^{z}ₘL^{z} (m less than 3).

The polymerization of the invention may be carried out in the substantial absence of other cocatalysts, activators and scavengers that do not confirm with the general formula, such as TEAl and TIBAl.

The cocatalyst of the invention may be used with any Ziegler-Natta catalysts system. Generally, a Ziegler-Natta catalyst system includes a transition metal compound generally represented by the formula:
MRₓ
where M may be a transition metal, R may be a halogen or a hydrocarboxyl, and x may be the valence of the transition metal. M may be selected from the group of metals consisting of Groups IV, V, VI and VII metals, including subgroups. Typically, M may be a group IVB metal such as titanium, chromium, or vanadium, and R may be chlorine, bromine, or an alkoxy group. The transition metal compound may be typically supported on an inert solid, e.g., magnesium chloride. For example, a Ziegler Natta catalyst system such as that disclose in the patent application titled Silica-Supported Ziegler Natta Catalyst for Polyolefin Production having a Ser. No. 11/122,920 and filed on May 5, 2005 by Vizzini, et al., may be used with the invention by substituting the cocatalysts of the invention for the TEAl cocatalysts disclosed therein. This application is fully incorporated herein by reference. The catalysts systems disclosed in U.S. Pat. No. 6,486,274 to Gray, et al.; U.S. Pat. No. 6,693,058 to Gray, et al.; and U.S. Pat. No. 6,864,207 to Knoeppel, et al, may also be similarly used with the invention and are also fully incorporated by reference. Other patents disclosing synthesis or and polymerization using Ziegler-Natta catalyst systems include U.S. Pat. Nos. 3,644,318; 4,107,413; 4,294,721; 4,439,540; 4,114,319; 4,220,554; 4,460,701; 4,562,173; 5,066,738; 6,174,971; 6,734,134; 6,864,207; 6,916,895; 6,930,071; and 6,693,058, all of which are fully incorporated herein by reference.

In practicing an embodiment of the invention, the conventional TEAL or TIBAl cocatalyst may be replaced with a cocatalyst of the invention that conforms to Formula I. The invention cocatalysts are applied in the same way and in approximately the same ratios and amounts. As with any chemical process, there may be some adjustment of the process to account for process variability, but these adjustments are within the knowledge and scope of one of ordinary skill in the art of preparing polymers and does not represent experimentation.

For example, in one embodiment, the invention may be used to prepare polyolefins using a Ziegler-Natta catalysts system substantially similar to that of U.S. Pat. No. 6,147,971 to Chen, et al. This patent is fully incorporated herein by reference. In this application, the cocatalyst may be also described or designated as an activator. Whether described as an activator or a cocatalyst, the cocatalyst of the invention conforms to Formula I or Formula Ia.

The activators may or may not be associated with or bound to a support, either in association with the catalyst component or separate from the catalyst component.

In one embodiment, the catalyst preparation may be generally described as comprising at least three steps: (1) preparation of a dialkoxide as the reaction product of a metal dialkyl and an alcohol; (2) preparation of a soluble catalyst precursor as the reaction product of the metal dialkoxide and a halogenating/titanating agent; and (3) precipitation of a final solid catalyst component as the reaction product of the soluble catalyst precursor and a precipitating agent. The precipitating agent may in some embodiments also be a halogenating/titanating agent. While additional steps may also be included in practicing the invention, as will be known to those skilled in the art, such as, for example, additional halogenating/titanating steps, the three enumerated steps are considered to be those conventionally employed, although execution of each step may occur at a different site or manufacturing facility.

The metal dialkyls may include Group IIA metal dialkyls. The metal dialkyl may be, for example, a magnesium dialkyl. Suitable and non-limiting examples include diethyl magnesium, dipropyl magnesium, dibutyl magnesium, butylethyl magnesium (BEM), and the like. In one embodiment butylethyl magnesium may be employed.

The alcohol may be, in one embodiment, any compound conforming to the formula R¹OH and yielding the desired metal dialkoxide upon reaction as described hereinabove may be utilized. In the given formula R¹ may be an alkyl group of 2 to 20 carbon atoms. Non-limiting examples of suitable alcohols include ethanol, propanol, isopropanol, butanol, isobutanol, 2-methyl-pentanol, 2-ethylhexanol, and the like. While it is believed that almost any alcohol may be utilized, whether linear or branched, a higher order branched alcohol, for example, 2-ethyl-1-hexanol (also called 2-ethylhexanol), may be utilized in particular embodiments.

The amount of alcohol relative to the metal dialkyl may vary over a wide range, provided that the result is the desired metal alkoxide. For example, a level of from about 0.01 to about 10 equivalents of alcohol relative to the metal dialkyl may be employed. In some embodiments a level ranging from about 0.5 to about 6 equivalents may be used, and in other embodiments a level ranging from about 1 to about 3 equivalents may be selected.

A problem that may be encountered when a selected metal dialkyl is added to a solution is a dramatic increase in the solution's viscosity. This undesirably high viscosity may be reduced in by adding to the solution an aluminum alkyl, such as, for example, triethyl aluminum (TEAl), which operates to disrupt the association between the individual alkyl metal molecules. In the practice of the invention, rather than use TEAl, one of the invention alkyl aluminums would be used such as TIBAl. In some embodiments it may be therefore desirable to include the alkyl aluminum, in an alkyl aluminum-to-metal ratio of from 0.001:1 to 1:1. In other embodiments the ratio may be from 0.01:1 to 0.5:1; and in still other embodiments the ratio may be from 0.03:1 to 0.2:1. In addition, an electron donor such as an ether, for example, diisoamyl ether (DIAE), may be used to further reduce the viscosity of the alkyl metal. The typical ratio of electron donor to metal ranges from 0:1 to 10:1 and may range from 0.1:1 to 1:1.

In the practice of an embodiment of the invention the metal dialkoxide produced by the reaction of dialkyl metal and alcohol may be a magnesium compound of the general formula Mg(OR²)₂ wherein R² may be a hydrocarbyl or substituted hydrocarbyl of 1 to 20 atoms. In one embodiment the metal dialkoxide may be non-reducing. Non-limiting examples of species of metal dialkoxides which may be used include magnesium di(2-ethylhexoxide) and other Group IIA metal dialkoxides, may be produced by reacting an alkyl magnesium compound (MgR³R⁴, i.e., a metal dialkyl wherein R³ and R⁴ are each independently any alkyl group of from 1 to 10 carbon atoms) with an alcohol (R¹OH) and an aluminum alkyl (AlR⁵₃ wherein R⁵ is any alkyl group of from 1 to 10 carbon atoms). Suitable MgR³R⁴ compounds may include, for example, diethyl magnesium, dipropyl magnesium, dibutyl magnesium, and butylethyl magnesium (BEM). The MgR³R⁴ compound may be BEM, wherein the reaction products, in addition to the magnesium dialkoxide, are denoted as R³H and R⁴H and are butane and ethane, respectively.

In the second step of the generalized reaction scheme, the metal dialkoxide may be reacted with a halogenating agent to form a soluble catalyst precursor. This step may be accomplished in one or several parts. In this case a compound conforming to the formula ClAR⁶ₓ may in some embodiments be selected as the halogenating agent. In the formula, A may be a non-reducing oxyphilic compound which may be capable of exchanging one chloride for an alkoxide, R⁶ may be a hydrocarbyl or substituted hydrocarbyl, and x may be the valence or formal oxidation state of A minus 1. Examples of A include titanium, silicon, aluminum, carbon, tin and germanium, and in some embodiments titanium or silicon wherein x may be 3. Where titanium is included, the agent may be referred to as a halogenating/titanating agent. Examples of R⁶ include methyl, ethyl, propyl, isopropyl and the like having from 2 to 6 carbon atoms. A non-limiting example of a halogenating/titanating agent that may be used may be ClTi(OⁱPr)₃ and, as a halogenating agent, ClSiMe₃, wherein Me may be methyl.

The halogenation may be generally conducted in a hydrocarbon solvent under an inert atmosphere. Non-limiting examples of suitable solvents include toluene, heptane, hexane, octane and the like. In this halogenating step, the mole ratio of metal alkoxide to halogenating agent may be, in some embodiments, in the range of about 6:1 to about 1:3, and in other embodiments from about 3:1 to 1:2, and in still other embodiments from about 2:1 to 1:2, and in yet other embodiments may be about 1:1.

Halogenation may be carried out at a temperature from about 0° C. to about 100° C. and for a reaction time in the range of from about 0.5 to about 24 hours. In other embodiments a temperature of from about 20° C. to about 90° C. may be used, and the reaction time may range from about 1 hour to about 4 hours.

The halogenation that takes place results in a reaction product which may be the soluble catalyst precursor, which may in some embodiments be of uncertain composition. Regardless of the constituents or the nature of their association, in this embodiment, the catalyst precursor may be substantially soluble, which may be defined herein as soluble at a level of at least about 90 percent by weight, and in desirable embodiments more than about 95 percent by weight, in the catalyst synthesis solution.

Following formation of the soluble catalyst precursor, a halogenating/titanating agent may be used for the purpose of precipitating the desired final solid catalyst component, i.e., thereby providing a supported catalyst. Thus, this agent may be herein referred to as the “precipitating agent” in order to more clearly separate it, by virtue of its effect, from other halogenating agents, some of which may contain titanium and therefore double as titanating agents, that are used in forming the soluble catalyst precursor via reaction of that agent with the metal dialkoxide.

The precipitating agent may be, in some embodiments, blends of two tetra-substituted titanium compounds with all four substituents being the same and the substituents being a halide. In other embodiments, the precipitating agent may be a single compound. If a blend is chosen, a combination of a titanium halide and an organic titanate may, in some embodiments, be selected. For example, a blend of TiCl₄ and Ti(OBu)₄, wherein Bu is butyl, may be utilized. In some desirable embodiments a blend of Ti(OBu)Cl₃ and Ti(OBu)₂Cl₂ may be selected as the precipitating agent. Where a blend of TiCl₄ and Ti(OBu)₄ is selected, for example, the proportion of the constituents may vary over a range of from 0.5:1 to 6:1, and in some embodiments from about 2:1 to 3:1. The support may be generally composed of an inert solid, which may be chemically unreactive with any of the components of the conventional Ziegler-Natta catalyst. In some embodiments, where magnesium containing starting materials are selected, the support is often a magnesium compound. Examples of the magnesium compounds which may be used to provide a support source for the catalyst component are magnesium halides, dialkoxymagnesium, alkoxymagnesium halides, magnesium oxyhalides, dialkylmagnesiums, magnesium oxide, magnesium hydroxide, and carboxylates of magnesium.

The amount of precipitating agent utilized may be desirably sufficient to precipitate a solid product from the solution. Desirable embodiments include employing a precipitating agent concentration of from about 0.5:1 to about 5:1, typically from about 1:1 to about 4:1, and in certain embodiments in the range of from about 1.5:1 to about 2.5:1.

In some embodiments the precipitation may be carried out at room temperature. The solid catalyst component may be then recovered by any suitable recovery technique known to those skilled in the art, and then desirably washed at room/ambient temperature with a solvent, such as hexane. Generally, the solid catalyst component may be washed until the concentration of soluble titanium species, [Ti], may be less than about 100 mmol/L. In the invention [Ti] represents any titanium species capable of acting as a second generation Ziegler catalyst, which would comprise titanium species that are not part of the reaction products as described herein. The resulting catalyst component may then, in some embodiments, be subjected to additional halogenation/titanation steps, if desired, to produce alternative and/or additional catalyst products. After each halogenation/titanation step the solid product may be washed.

Optionally, an electron donor may also be employed, during the halogenation/titanation, to produce the soluble catalyst precursor; during the precipitation, to produce the (solid) catalyst component; or during subsequent halogenations/titanations, to produce alternative catalyst components. Electron donors useful in the preparation of polyolefin catalysts are well known in the art, and any suitable electron donor that will provide a suitable catalyst may be used. Electron donors, also known as Lewis bases, are typically organic compounds of oxygen, nitrogen, phosphorus, or sulfur which are capable of donating an electron pair to the catalyst.

Such electron donor may be a monofunctional or polyfunctional compound, and may be selected from among the aliphatic or aromatic carboxylic acids and their alkyl esters, the aliphatic or cyclic ethers, ketones, vinyl esters, acryl derivatives, particularly alkyl acrylates or methacrylates, and silanes. An example of a suitable electron donor may be di-n-butyl phthalate. A generic example of a suitable electron donor is an alkylsilylalkoxide of the general formula RSi(OR′)₃, e.g., methylsilyltriethoxide [MeSi(OEt₃)], where R and R′ are alkyls with 1-5 carbon atoms and may be the same or different.

An internal electron donor may be used in the synthesis of the catalysts and an external electron donor, or stereoselectivity control agent to activate the catalyst at polymerization. An internal electron donor may be used in the formation reaction of the catalyst during the halogenation or halogenation/titanation steps. Compounds suitable as internal electron donors for preparing conventional supported Ziegler-Natta catalyst components include ethers, diethers, ketones, lactones, electron donor compounds with nitrogen, phosphorus and/or sulfur atoms, and specific classes of esters. Particularly suitable are the esters of phthalic acid, such as diisobutyl, dioctyl, diphenyl and benzylbutylphthalate; esters of malonic acid, such as diisobutyl and diethyl malonate; alkyl and aryl pivalates; alkyl, cycloalkyl and aryl maleates; alkyl and aryl carbonates, such as diisobutyl, ethylphenyl, and diphenyl carbonate; and succinic acid esters, such as mono and diethyl succinate.

External electron donors which may be utilized in the preparation of a catalyst according to the present invention include organosilane compounds such as alkoxysilanes of the general formula SiRₘ(OR′)₄₋ₘ wherein R may be selected from the group consisting of alkyl, cycloalkyl, aryl and vinyl groups; R′ may be an alkyl group; and m may be 0-3, wherein R may be the same as R′; and further wherein, when m is 0, 1 or 2, the R′ groups may be the same or different; and when m is 2 or 3, the R groups may be the same or different.

The external electron donor useful in the invention may be selected from a silane compound of the following formula: 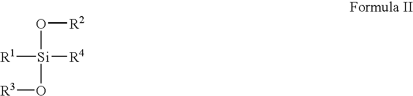
wherein R¹ and R⁴ are both an alkyl or cycloalkyl group containing a primary, secondary or tertiary carbon atom attached to the silicon, R¹ and R⁴ being the same or different; and R² and R³ being alkyl or aryl groups. R¹ may be methyl, isopropyl, isopentyl, cyclohexyl, or t-butyl; R² and R³ may be methyl, ethyl, propyl or butyl groups and are not necessarily the same; and R⁴ may also be methyl, isopropyl, cyclopentyl, cyclohexyl or t-butyl. Specific external electron donors are cyclohexyl methyldimethoxy silane (CMDS), diisopropyl dimethoxysilane (DIDS), cyclohexylisopropyl dimethoxysilane (CIDS), dicyclopentyl dimethoxysilane (CPDS) and di-t-butyl dimethoxysilane (DTDS).

The catalyst component made as described hereinabove may be combined with an organometallic catalyst component (a “preactivating agent”) to form a preactivated catalyst system suitable for the polymerization of olefins. Typically, the preactivating agents which are used together with the catalyst component of the invention are organometallic compounds such as aluminum alkyls, aluminum alkyl hydrides, lithium aluminum alkyls, zinc alkyls, magnesium alkyls and the like. Organoaluminum compounds are used in some embodiments. Where such is selected it is frequently an aluminum alkyl of the formula AlR₃ wherein at least one R may be an alkyl having 1-8 carbon atoms or a halide, and wherein each R may be the same or different.

The catalyst and inventive cocatalyst may be used in any process for the homopolymerization or copolymerization of any type of alpha-olefins. For example, the present catalyst may be useful for catalyzing ethylene, propylene, butylenes, pentene, hexane, 4-methylpentene and other alpha-alkenes having at least 2 carbon atoms, and also for mixtures thereof. Polymers of the above may exhibit desirable properties such as broader molecular weight distribution and multi-modal distributions such as bimodality and trimodality. The catalyst component of the invention may be utilized for the polymerization of ethylene to produce polyethylene.

Various polymerization processes may be employed with the invention, such as, for example, single and/or multiple loop processes, continuous stir tank reactors, and gas phase reactor processes. An example of a multiple loop process than may employ the invention may be a double loop system in which the first loop produces a polymerization reaction in which the resulting polyolefin has a lower molecular weight than the polyolefin produced from the polymerization reaction of the second loop, thereby producing a resultant resin having broader molecular weight distribution and/or bimodal characteristics. In the alternative, another example of a multiple loop process that may employ the present invention may be a double loop system in which the first loop produces a polymerization reaction in which the resulting polyolefin has a significantly different molecular weight than the polyolefin produced from the polymerization reaction of the second loop, thereby producing a resultant resin having broader molecular weight distribution and/or bimodal characteristics.

The polymerization process may be, for example, slurry or gas phase. A catalyst component of the invention may be used in slurry phase polymerization. Polymerization conditions (e.g., temperature and pressure) are dependent upon the type of equipment utilized in the polymerization process, as well as the type of polymerization process utilized, and are known in the art. Generally, the temperature will be in a range of from about 50 to about 120° C., and the pressure in a range of from about 10 to about 1000 psi.

The activity of the resulting catalyst of embodiments of the invention will be at least partially dependent upon the polymerization process and conditions, such as, for example, equipment utilized and temperature of reaction. For example, in the embodiment of polymerization of ethylene to produce polyethylene, generally the catalyst component will have a mileage of at least 5,000 g PE/g catalyst, but may have a mileage of greater than 50,000 g PE/g catalyst, and, in some embodiments, the mileage may be greater than 100,000 g PE/g catalyst.

The catalyst systems described herein, including the identified family of cocatalysts, may be used over a wide range of temperatures and pressures. The temperatures may be in the range of from about −60° C. to about 280° C., or from about 50° C. to about 200° C. and the pressures employed may be in the range of from 1 to about 500 atmospheres or higher. Examples of solution processes are described in U.S. Pat. Nos. 4,271,060; 5,001,205; 5,236,998; and 5,589,555, which patents are fully incorporated herein by reference.

One example of a gas phase polymerization process generally employs a continuous cycle, wherein a cycling gas stream (otherwise known as a recycle stream or fluidizing medium) may be heated in a reactor by heat of polymerization. The heat may be removed from the recycle stream in another part of the cycle by a cooling system external to the reactor. The gaseous stream containing one or more monomers may be continuously cycled through a fluidized bed in the presence of a catalyst under reactive conditions. The gaseous stream may be withdrawn from the fluidized bed and recycled back into the reactor. Simultaneously, polymer product may be withdrawn from the reactor and fresh monomer may be added to replace the polymerized monomer. See, for example, U.S. Pat. Nos. 4,543,399; 4,588,790; 5,028,670; 5,317,036; 5,352,749; 5,405,922; 5,436,304; 5,462,999; 5,616,661; and 5,668,228; which patents are fully incorporated herein by reference.

The reactor pressure in a gas phase process may vary from about 100 psig to about 500 psig, or from about 200 to about 400 psig, or from about 250 to about 350 psig. The reactor temperature in a gas phase process may vary from 30° C. to 120° C. or 60° C. to 115° C. or 70° C. to 110° C. or 70° C. to 95° C.

Other gas phase processes contemplated by the process includes those described in U.S. Pat. Nos. 5,627,242; 5,665,818; and 5,677,375 and European publications EP-A-0 794 200; EP-A-0 802 202; and EP-B-634 421, which patents are fully incorporated herein by reference.

Slurry processes generally include forming a suspension of solid, particulate polymer in a liquid polymerization medium, to which monomers and optionally hydrogen, along with catalyst, are added. The suspension, including the polymerization diluent, may be intermittently or continuously removed from the reactor where the volatile components may be separated from the polymer and recycled, optionally after a distillation, to the reactor. The liquid phase diluent employed in the polymerization medium may be typically an alkane having from 3 to 7 carbon atoms. The medium employed should be liquid under the conditions of polymerization and relatively inert, such as hexane or isobutane.

The catalyst as a slurry or as a dry free flowing powder may be injected regularly to the reactor loop, which may itself be filled with circulating slurry of growing polymer particles in a monomer. Hydrogen, optionally, may be added as a molecular weight control. The reactor may be maintained at a pressure of from about 0 psig to about 1000 psig and a temperature of from about 38° C. to about 120° C. Reaction heat may be removed through the loop wall since much of the reactor may be in the form of a double-jacketed pipe. The slurry may exit the reactor at regular intervals or continuously to a heated low pressure flash vessel, rotary dryer and a nitrogen purge column in sequence for removal of unreacted monomer and comonomers. The resulted hydrocarbon free powder may then be compounded for use in various applications. Alternatively, other types of slurry polymerization processes may be used, such stirred reactors may be series, parallel or combinations thereof.

A slurry and/or polymerization process generally includes pressures in the range of from about 0 to about 1000 psig and even greater and temperatures of from about 0° C. to about 120° C.

A particular advantage of the invention may be that the resulting polymers exhibit a molecular weight distribution that may be desirably unimodal or bimodal and also slightly broader than that attained using TIBAl or TEAl at both higher and lower end molecular weights. Molecular weight distribution (MWD) may be defined as the weight average molecular weight divided by the number average molecular weight (Mw/Mn). The inventive process produces polymers that may, in some embodiments, exhibit MWD's of from about 3 to about 10. In other embodiments such MWD's may be from about 4 to about 8 polydisperity units. Such changes may be exploited to fine-tune the shear thinning behavior as based on final product needs. In some embodiments the bulk density may also be improved relative to molar cocatalyst concentration in the diluent, as compared with bulk densities obtained in polymerizations that are essentially identical but using TEAl or TIBAl as the cocatalyst.

Selection of monomers to prepare the polyolefins, including homopolymers, copolymer, terpolymers and the like, will be within the skill of those in the art. Such polymers may include those prepared using ethylene, propylene, propylene-ethylene, propylene-ethylene-butylene, propylene-ethylene-octene, propylene-ethylene-hexene and the like. Other terpolymers include those referred to as ethylene propylene diene monomer (EPDM) resins prepared using propylene, ethylene and one or more of group consisting of dicyclopentadiene (DCPD), ethylidene norbornene (ENB) or 1,4 hexadiene; 5-vinylnorbornene and mixtures thereof. The EPDM resins may be prepared using a diene having a terminal and an internal unsaturation.

Generally, the polymers produced as disclosed herein and blends thereof may be useful in such forming operations as film, sheet, pipe and fiber extrusion and co-extrusion as well as blow molding, injection molding and rotary molding. Films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, geomembranes and pond liners. Molded articles include single and multi-layered constructions in the form of bottles, tanks, large hollow articles, rigid food containers, toys, and the like.

One aspect of the invention may be the discovery that there may be an unfavorable interaction between the decomposition products of TEAl and TIBAl and the polymerization system employed. In one embodiment, the invention may be practiced using TEAl and TIBAl as co-catalysts by selecting as the reaction solvent a solvent from which butene and isobutylene may be easily and effectively separated.

The following examples are provided to more fully illustrate the invention. As such, they are intended to be merely illustrative and should not be construed as being limitative of the scope of the invention in any way. Those skilled in the art will appreciate that modifications may be made to the invention as described without altering its scope. For example, selection of particular catalysts, monomers or combinations of monomers, and modifications such as of catalyst concentration, feed rate, processing temperatures, pressures and other conditions, and the like, not explicitly mentioned herein but falling within the general description hereof, will still fall within the intended scope of both the specification and claims appended hereto.

### EXAMPLES

### Example 1

A Ziegler-Natta catalyst was prepared as follows. In a nitrogen purge box, 1412.25 g (2.00 moles) of butyl ethyl magnesium (BEM) solution, 27.60 g (0.060 moles) of TEAl solution (24.8% in heptane), and 189.70 g (1.20 moles) of DIAE were added to a 3 L round bottom flask. The contents were then transferred to a 20 L Buchi reactor via cannula under a nitrogen flow. The flask was then rinsed with approximately 400 ml of hexane which was transferred to the reactor. The stirrer was set to 350 rpm.

2-ethylhexanol (543.60 g, 4.21 moles) was added to a 1 L bottle and capped. It was then diluted to a total volume of 1 L with hexane and added to the reactor. The initial head temperature was 25.3° C. and reached a maximum temperature of 29.6° C. Following the addition (which was performed over approximately 2 hours), the bottle was rinsed with 400 ml of hexane which was transferred to the reactor. The reaction mixture was left stirring at 350 rpm overnight under a nitrogen pressure of 0.5 bar (0.49 atmospheres) and the heat exchanger was turned off.

With the reactor temperature regulated to 25° C., a solution of chloro-titanium triisopropoxide in hexanes (1550 g , 2.00 total moles) was added. The total addition time was approximately five hours and a slight (1.0° C.) exotherm was seen with the ClTi(OiPr)3 addition. After the addition, the bottle used to transfer the ClTi(OiPr)3 was rinsed with 200 ml of hexane which was transferred to the reactor. The reaction mixture was left stirring at 350 rpm overnight under nitrogen pressure of 0.5 bar (0.49 atmospheres) at ambient temperature.

A titanium tetrachloride/titanium tetrabutoxide (TiCl₄/Ti(OBu)₄) mixture was prepared in a 5 L round bottom flask using standard schlenk line techniques. In a 1 L pressure bottle, 680.00 g (1.99 moles) of Ti(OBu)₄ was diluted to 1 L total volume with hexane. This solution was then cannula transferred to the reactor. The bottle was rinsed with 200 ml of hexane and the hexane was transferred to the reactor. In a 1 L measuring cylinder, 440 ml (˜760 g, 4.00 moles) of TiCl₄ was diluted to a total volume of 1 L with hexane. The solution in the 5 L flask was stirred and the TiCl₄ solution was added to the reactor dropwise under N₂ pressure via cannula. After the addition was complete, the 1 L cylinder was rinsed with 200 ml of hexane which was transferred to the reactor. After 1 hour, the reaction mixture was diluted to 4 L total volume with hexane and stored in the flask prior to use.

With the reactor controlled at 25° C., the TiCl₄ /Ti(OBu)₄ mixture was transferred to the 20 L reactor via cannula. The initial head space temperature was 24.7° C. and reached a maximum temperature of 26.0° C. during a 225 minute addition. Following the additions, the vessel was rinsed with 1 L of hexane and allowed to stir for 1 hour.

The stirrer was turned off and the solution allowed to settle for 30 minutes. The solution was decanted by pressuring the reactor to 1 bar (0.99 atmospheres) and removing the solution from the settled solid with a dip tube. The catalyst was then washed three times using the following procedure. Using a pressure vessel on a balance, 2.7 kg of hexane was weighed into the vessel and then transferred to the reactor. The stirrer was turned on and the catalyst mixture was agitated for 15 minutes. The stirrer was then turned off and the mixture was allowed to settle for 30 minutes. The solution phase was decanted from the settle solid and the sample was reslurried with hexane. This procedure was repeated. After the third addition of hexane, the slurry was allowed to settle overnight and the heat exchanger was turned off.

The supernatant was decanted, and 2.0 kg of hexane were added to the reactor. Stirring was resumed at 350 rpm and the heat exchanger was turned on and set to 25° C. In a one liter graduated cylinder, 440 mL (760 g, 4.00 moles) of titanium tetrachloride were added. The TiCl₄ was diluted to 1 L with hexane, and half of the solution was transferred to the reactor via cannula. The initial head temperature of 24.7° C. increased by 0.5° C. during the addition. The total addition time was about 45 minutes. After one hour, the stirrer was turned off and the solids were allowed to settle for 30 minutes. The supernatant was decanted, and the catalyst was washed once with hexane following the procedure described above. After the wash was complete, 2.0 kg of hexane was transferred to the reactor and the agitation was resumed. The second TiCl₄ drop was completed in a similar manner to that described above using the remaining 500 mL of solution. Following the addition, the cylinder was rinsed with 400 mL of hexane, which was added to the Buchi. After one hour of reaction, the stirrer was turned off and the solids were allowed to settle for 30 minutes. The supernatant was then decanted, and the catalyst washed three times with hexane. 2.0 kg of hexane was then transferred to the reactor.

In a 1 L pressure-rated bottle, 144.8 g (312 mmol) of TEAl solution (25.2% in hexane) were added. The bottle was capped and diluted to 1 L with hexane. This solution was then transferred to the reaction mixture via cannula using the mass flow controller. During the 120 minute addition, the color of the slurry turned dark brown. The initial head temperature was 24.5° C. and reached a maximum temperature of 25.3° C. Following the addition, the bottle was rinsed with 400 mL of hexane, which was transferred to the reactor. After 1 hour of reaction, the stirrer was shut off and the catalyst was allowed to settle for 30 minutes. The supernatant was decanted and the catalyst was washed once following the procedures previously described. Following the wash, 2.7 kg of hexane was added to the reactor. The contents were then transferred to a three gallon pressure vessel. The Buchi was rinsed with 1.0 kg and 0.5 kg of hexane, which were added to the pressure vessel. Estimated catalyst yield was 322 g. The catalyst was used as set forth below.

A series of bench-scale polymerizations to prepare polyethylene were carried out according to the polymerization conditions shown in Table 1:

TABLE 1

| Diluent | Hexane |
|---|---|
| Pressure (psig) | 125 |
| Temperature (° C.) | 80 |
| Cocatalyst amount (mmol/L) | 0.125, 0.25, 0.5, 1.0, 1.25 |
| C₂ Feed Rate (LPM) | 8 |
| H₂/C₂ Feed Ratio | 0.25 |
| Butene Feed Rate (g/h) | 15, 67.5 |
| Target Yield (g) | ˜250 |
| Polymerization Time (h) | 1 |

A polymer fluff was prepared using a 4 L Autoclave Engineer system fitted with four mixing baffles and two opposed pitch propellers. The reactor was first charged with hexane and then catalyst and hydrogen and then the monomers. At the conclusion of the polymerization time, the polymer fluff was collected and tested as disclosed in Tables 2 and 3.

Polymer Bulk Density was determined using ASTM D1895-69. Polymer D₅₀ was performed with laser scattering (Malvern Scirocco). Polymer fines were determined by tumbling a representative sample of each polymer made for about 20 minutes. A polymer sample of about 50 g was removed, weighed and screened for 10 minutes using a CSC Scientific Sieve Shaker and the amount of polymer fines of less than 125 micrometer size was determined by weighing. The resulting values were used to calculate the weight percent fines of less than 125 micrometer size for each polymer so tested.

High load melt index (HLMI) was determined using the procedures of ASTM D1238 using a load of 21.6 kg at a temperature of 190° C.

MI₅ melt index was determined using the procedures of ASTM D1238 using a load of 5 kg at a temperature of 190° C.

### Comparative Example 1

The process and testing of Example 1 were repeated substantially identically except that TEAl was used in place of TNOAl.

### Comparative Example 2

The process and testing of Example 1 was repeated substantially identically except that TIBAl was used in place of TNOAl.

As can be seen in the Tables and Figures, the use of TNOAl allows for the production of polymers with higher bulk densities and broader molecular weight distributions. The use of TNOAl also results in a higher degree of shear thinning as indicated by the SR5 (HLMl/Ml₅) values depicted in the Table 3.

TABLE 2

| | TEAl | | | TIBAl | | | | | |
|---|---|---|---|---|---|---|---|---|---|
| | Comparative | | | Comparative | | | TNOAl | | |
| | Example 1 | | | Example 2 | | | Example 1 | | |
| [Al] | D₅₀ | BD | Fines | D₅₀ | BD | Fines | D₅₀ | BD | Fines |
| mmol/L | (μ) | (g/cc) | (%) | (μ) | (g/cc) | (%) | (μ) | (g/cc) | (%) |
| 0.25 | 162 | 0.41 | 15.3 | 156 | 0.45 | 19.1 | 150 | 0.47 | 24.1 |
| 0.50 | 160 | 0.39 | 16.5 | 158 | 0.44 | 18.1 | 153 | 0.47 | 21.2 |
| 0.75 | 165 | 0.39 | 13.7 | 159 | 0.43 | 17.4 | 154 | 0.46 | 20.6 |
| 1.00 | 157 | 0.39 | 18.2 | 158 | 0.42 | 17.9 | 156 | 0.45 | 19.6 |
| 1.25 | 164 | 0.42 | 14.1 | 145 | 0.49 | 28.0 | 149 | 0.47 | 24.7 |

TABLE 3

| Cocatalyst | Aluminum [Al](mmol/L) | Polydisperity (Mw/Mn) | SR5 |
|---|---|---|---|
| EX 1 | 0.125 | 8.11 | 12.6 |
| TNOAl | 0.250 | 9.17 | 12.1 |
| | 0.500 | 8.56 | 12.3 |
| | 0.750 | 8.24 | 11.8 |
| | 1.000 | 6.75 | 12.3 |
| Comp. | 0.125 | 7.50 | 11.8 |
| EX 1 | 0.250 | 6.85 | 11.3 |
| TEAl | 0.500 | 6.64 | 10.4 |
| | 0.750 | 6.37 | 10.9 |
| | 1.000 | 6.36 | 10.3 |
| Comp. | 0.125 | 8.67 | 12.5 |
| Ex 2 | 0.250 | 8.41 | 10.6 |
| TIBAl | 0.500 | 7.94 | 12.0 |
| | 0.750 | 7.72 | 11.4 |
| | 1.000 | 7.69 | 11.7 |

What is claimed is:

1. A process for preparing a polyolefin, the process comprising using as components in a polymerization mixture:
a Ziegler-Natta catalyst,
a polymerization diluent, and
a cocatalyst having the general formula:
AlR^{z}(X^{z})ₙ
wherein:
R^{z} is a linear or branched organic moiety having at least 5 carbons and
X^{z} is hydrogen, or a linear or branched organic moiety having at least 5 carbons, or a heterocyclic moiety having at least 4 atoms, and
X^{z} is anionic (n=2) or di-anionic (n=1);
subject to the proviso that when n=2, each X^{z} may be the same or different and that both X^{z} moieties may not be hydrogen; and
an olefin.

2. The process of claim 1 wherein the cocatalyst is in the form of a Lewis base adduct conforming to the general formula:
AlR^{z}(X^{z})ₙL^{z}ₘ
wherein L^{z} is a Lewis base and m is an integer having a value of from 1 to 3.

3. The process of claim 2 wherein the Lewis base is selected from the group consisting of ethers, aliphatic amines, aromatic amines, phosphines and mixtures thereof.

4. The process of claim 3 wherein the Lewis base is diethyl ether.

5. The process of claim 1 wherein the R^{z} is selected from the group consisting of alkyls, halides, alkenyls, substituted alkyls, aryls, arylhalides, alkoxys, and mixtures thereof.

6. The process of claim 1 wherein the diluent is isobutane and the cocatalyst is selected from the group consisting of tri-n-octylaluminum, tri-n-hexylaluminum, and mixtures thereof.

7. The process of claim 1 wherein the polyolefin is prepared in a single loop reactor.

8. The process of claim 1 wherein the polyolefin is prepared in a double loop reactor.

9. The process of claim 1 wherein the polyolefin is prepared in a stirred reactor.

10. The process of claim 1 wherein the Ziegler-Natta catalyst conforms to the general formula MRₓ where M is a transition metal, R is a halogen or a hydrocarboxyl, and x is the valence of the transition metal.

11. The process of claim 10 wherein M is selected from the group consisting of Groups IV, V, VI and VII metals, and R is chlorine, bromine, or an alkoxy group.

12. The process of claim 1 wherein the Ziegler-Natta catalyst is a supported catalyst.

13. The process of claim 12 wherein the Ziegler-Natta catalyst is supported on a magnesium support.

14. A polymer prepared by the process of claim 1.

15. The polymer of claim 14 wherein the polymer has a higher bulk density than an otherwise identical polymer prepared using a TEAl or TIBAL cocatalyst instead of a cocatalyst conforming to the formula AlR^{z}(X^{z})ₙ.

16. The polymer of claim 14 wherein the polymer has a broader molecular weight distribution than an otherwise identical polymer prepared using a TEAL or TIBAl cocatalyst instead of a cocatalyst conforming to the formula AlR^{z}(X^{z})ₙ.

17. The polymer of claim 14 wherein the polymer has a higher degree of shear thinning than an otherwise identical polymer prepared using a TEAL or TIBAl cocatalyst instead of the a cocatalyst conforming to the formula AlR^{z}(X^{z})ₙ.

18. The polymer of claim 14 wherein the polymer is polyethylene.

19. The polymer of claim 14 wherein the polymer is copolymerized using ethylene and at least one additional monomer.

20. The polymer of claim 19 wherein the at least one additional monomer is selected from the group consisting of propylene, butene, pentene, hexene, heptane, octene, dicyclopentadiene (DCPD), ethylidene norbornene (ENB), 1,4 hexadiene, 5-vinylnorbornene, and mixtures thereof.

21. An article of manufacture comprising a polyolefin prepared using the process of claim 1.

22. The article of manufacture of claim 21 wherein the polyolefin is a film, a fiber, or a blow molded or injection molded article.
